(19) United States
(12) Patent Application Publication
(10) Pub. No.: US 2026/0214565 A1
(43) Pub. Date: Jul. 23, 2026

(54) Key Performance Indicator (KPI) Assurance for Energy Saving

(71) Applicant: Telefonaktiebolaget LM Ericsson (publ), Stockholm (SE)

(72) Inventors: Huaisong Zhu, Beijing (CN); Yanli Zheng, Beijing (CN); Fan Zhang, Beijing (CN); Rui Wu, Beijing (CN)

(21) Appl. No.: 19/134,830

(22) PCT Filed: Dec. 2, 2022
(86) PCT No.: PCT/CN2022/136279

§ 371 Date: Jun. 2, 2025

(51) Int. Cl. H04W 52/02; H04L 41/16; H04L 41/5009; H04W 24/08

(52) U.S. Cl. CPC H04W 52/0203; H04L 41/16; H04L 41/5009; H04W 24/08

(57) ABSTRACT

Methods and electronic device for KPI assurance for energy saving. A method at a network node (210) for facilitating a RAN (105) in managing its energy consumption comprises: receiving (S310, S410) one or more first target values for one or more first PIs for the RAN (105); receiving (S340, S420) one or more first current values for the one or more first PIs for the RAN (105); and determining (S350, S430) one or more second target values for one or more second PIs based on at least the one or more first current values and the one or more first target values, wherein the one or more second target values are used for one or more operations for managing energy consumption.

### TECHNICAL FIELD

The present disclosure is related to the field of telecommunication, and in particular, to a network node, a Radio Access Network (RAN) node, and methods for Key Performance Indicator (KPI) assurance for energy saving.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient Radio Access Network (RAN), such as a 5G New Radio (NR) RAN, will be required.

Carriers have been looking at energy efficiency for a few years now, but 5G will bring this to top of mind because it is going to use more energy than 4G. Some carriers spend on average 5% to 6% of their operating expenses, excluding depreciation and amortization, on energy costs, and this is expected to rise with the shift from 4G to 5G.

A typical 5G base station consumes up to twice or more the power of a 4G base station, and energy costs can grow even more at higher frequencies, due to a need for more antennas and a denser layer of small cells. Edge computing facilities needed to support local processing and new internet of things (IoT) services will also add to overall network power usage.

According to data on Remote Radio Unit (RRU)/Baseband Unit (BBU) needs per site, a typical 5G site has power needs of over 11.5 kilowatts, up nearly 70% from a base station deploying a mix of 2G, 3G, and 4G radios. 5G macro base stations may require several new, power-hungry components, including microwave or millimeter wave transceivers, field-programmable gate arrays (FPGAs), faster data converters, high-power/low-noise amplifiers and integrated MIMO antennas.

The increased power demands of a 5G base station can create several problems:
Insufficient AC power supply;
Insufficient battery capacity: more backup battery capacity is needed, yet traditional lead-acid batteries have low energy density and their capacities are difficult to expand;
Unable to support high-power long-distance transmission: in 5G scenarios requiring high power supply to remote active antenna units (AAUs), the voltage drop means that transmission distance is limited.

### SUMMARY

There are many ways to save energy for a RAN. For example, Machine Learning (ML)/Artificial Intelligence (AI) could be utilized to optimize the energy saving decisions by leveraging on the data collected in the RAN network. However, in some cases, an ML/AI based decision maker may make decisions resulting in an unacceptable network performance, that can be reflected by one or more degraded KPIs. For example, even if there is an annual or quadrennial sport game (e.g., the Olympic Games) in a stadium, aggressive parameters for energy saving will still be recommended by the ML/AI based decision maker to the base stations that serve the stadium because it is predicted based on the historical data that there should be no traffic since the decision maker is not aware of the sport game. In such a case, the remaining active cells/RU components will be overloaded and the network performance will deteriorate significantly.

Therefore, ML/AI could contribute accuracy of KPI assurance only from statistic point of view, while some KPIs need consider almost the worst case. Purely rely on ML/AI is not enough for KPI assurance of energy saving.

Therefore, to address or at least alleviate the above issues, some embodiments of the present disclosure are provided.

According to a first aspect of the present disclosure, a method at a network node for facilitating a RAN in managing its energy consumption is provided. The method comprises: receiving one or more first target values for one or more first performance indicators (PIs) for the RAN; receiving one or more first current values for the one or more first PIs for the RAN; and determining one or more second target values for one or more second PIs based on at least the one or more first current values and the one or more first target values, wherein the one or more second target values are used for one or more operations for managing energy consumption.

In some embodiments, the one or more first PIs indicate one or more performance metrics for the RAN that are perceptible by an end user. In some embodiments, the one or more first PIs indicate at least one of: a performance metric in term of accessibility; a performance metric in term of retainability; a performance metric in term of integrity; a performance metric in term of mobility; and a performance metric in term of availability. In some embodiments, the one or more second PIs indicate one or more performance metrics for status of the RAN that are non-perceptible by an end user. In some embodiments, the one or more second PIs indicate at least one of: a maximum path loss; a Medium Access Control (MAC) layer scheduling latency; a schedulable physical layer channel capacity; and a schedulable session per Transmission Time Interval (TTI).

In some embodiments, the step of receiving the one or more first target values comprises: receiving, from an operator of the RAN, the one or more first target values. In some embodiments, the method further comprises at least one of: determining whether the one or more first target values are feasible or not; and determining whether the first target values conflict to each other or not when there are multiple first target values. In some embodiments, the method further comprises: providing the operator of the RAN with an alarm in response to determining at least one of: at least one of the first target values is not feasible; and at least two of the first target values conflict to each other. In some embodiments, the method further comprises: determining baseline values for the one or more first PIs, each of which indicating a performance metric without performing any operation for energy saving, wherein the step of determining whether the one or more first target values are feasible or not comprises at least one of: determining at least one of the first target values is not feasible in response to determining that the at least one first target value indicates a requirement higher than that indicated by at least one corresponding baseline value; and determining all the first target values are feasible in response to determining that each of the first target values indicates a requirement lower than or equal to that indicated by a corresponding baseline value.

In some embodiments, the step of determining whether the first target values conflict to each other or not when there are multiple first target values comprises at least one of: determining that the multiple first target values do not conflict to each other in response to determining that none of the multiple first target values indicates a requirement conflicting to that indicated by any other of the multiple first target values; and determining that at least two of the multiple first target values conflict to each other in response to determining that the at least two first target values indicate requirements conflicting to each other. In some embodiments, the step of receiving the one or more first current values comprises: monitoring the RAN for its current values for the one or more first PIs.

In some embodiments, the step of determining the one or more second target values comprises: performing a closed loop control procedure to determine the one or more second target values based on at least the one or more first current values and the one or more first target values, wherein the one or more first current values and the one or more first target values are inputs to the closed loop control procedure, the one or more second target values are outputs from the closed loop control procedure, and a control target for the closed loop control procedure is at least one of: have the one or more first current values meet the one or more first target values; minimize differences between the one or more first current values and the one or more first target values, respectively; minimize a difference between at least one of the first current values and its corresponding first target value; and have the one or more first current values meet the one or more first target values to the maximum extent. In some embodiments, the closed loop control procedure is a deviation based control procedure. In some embodiments, a second target value for a second PI is determined as a sum of a second target value for the second PI in a previous cycle and an adjustment value, wherein the adjustment value is determined as a product of a constant and a difference between a first current value for a first PI and a first target value for the first PI.

In some embodiments, a mapping between the one or more first PIs and the one or more second PIs is predetermined or configured, wherein the mapping indicates which one or ones of the first PIs are involved in determining a second target value for a second PI. In some embodiments, the method further comprises: triggering the RAN to perform the one or more operations for managing energy consumption based on at least the one or more second target values. In some embodiments, the step of triggering the RAN to perform one or more operations comprises: transmitting, to one or more RAN nodes in the RAN, the one or more second target values to enable the one or more RAN nodes to determine the one or more operations to be performed based on at least the one or more second target values and one or more second current values for the one or more second PIs.

In some embodiments, the one or more first current values and the one or more second target values are periodically determined. In some embodiments, the network node comprises an Operations & Maintenance (O&M) node.

According to a second aspect of the present disclosure, a network node is provided. The network node comprises: a processor; a memory storing instructions which, when executed by the processor, cause the processor to perform any of the methods of the first aspect.

According to a third aspect of the present disclosure, a network node for facilitating a RAN in managing its energy consumption is provided. The network node comprises: a first receiving module configured to receive one or more first target values for one or more first PIs for the RAN; a second receiving module configured to receive one or more first current values for the one or more first PIs for the RAN; and a determining module configured to determine one or more second target values for one or more second PIs based on at least the one or more first current values and the one or more first target values, wherein the one or more second target values are used for one or more operations for managing energy consumption. Further, the network node comprises one or more further modules, each of which performs any of the steps of any of the methods of the first aspect.

According to a fourth aspect of the present disclosure, a method at a RAN node for managing its energy consumption is provided. The method comprises: receiving, from a network node, one or more second target values for one or more second PIs that are determined based on at least one or more first target values and one or more first current values for one or more first PIs; and determining one or more operations to be performed for managing its energy consumption based on at least the one or more second target values.

In some embodiments, the one or more first PIs indicate one or more performance metrics that are perceptible by an end user. In some embodiments, the one or more first PIs indicate at least one of: a performance metric in term of accessibility; a performance metric in term of retainability; a performance metric in term of integrity; a performance metric in term of mobility; and a performance metric in term of availability. In some embodiments, the one or more second PIs indicate one or more performance metrics that are non-perceptible by an end user. In some embodiments, the one or more second PIs indicate at least one of: a maximum path loss; a MAC layer scheduling latency; a schedulable physical layer channel capacity; and a schedulable session per TTI. In some embodiments, the step of determining one or more operations comprises: determining the one or more operations by a Machine Learning (ML)/Artificial Intelligence (AI) assisted decision making module based on at least one of: the one or more second target values; a measurement report; a load estimation; and an energy estimation. In some embodiments, the one or more second target values are periodically received and the one or more operations to be performed for managing its energy consumption are periodically determined. In some embodiments, the method further comprises: performing the one or more operations.

According to a fifth aspect of the present disclosure, a RAN node is provided. The RAN node comprises: a processor; a memory storing instructions which, when executed by the processor, cause the processor to perform any of the methods of the fourth aspect.

According to a sixth aspect of the present disclosure, a RAN node for managing its energy consumption is provided. The RAN node comprises: a receiving module configured to receive, from a network node, one or more second target values for one or more second PIs that are determined based on at least one or more first target values and one or more first current values for one or more first PIs; and a determining module configured to determine one or more operations to be performed for managing its energy consumption based on at least the one or more second target values. Further, the RAN node comprises one or more further modules, each of which performs any of the steps of any of the methods of the fourth aspect.

According to a seventh aspect of the present disclosure, a computer program comprising instructions is provided. The instructions, when executed by at least one processor, cause the at least one processor to carry out any of the methods of the first aspect or the fourth aspect.

According to an eighth aspect of the present disclosure, a carrier containing the computer program of the seventh aspect. In some embodiments, the carrier is one of an electronic signal, optical signal, radio signal, or computer readable storage medium.

According to a ninth aspect of the present disclosure, a telecommunication network is provided. The telecommunication network comprises: a network node; and a RAN comprising one or more RAN nodes, wherein the network node is configured to: receive one or more first target values for one or more first PIs for the RAN; receive one or more first current values for the one or more first PIs for the RAN; and determine one or more second target values for one or more second PIs based on at least the one or more first current values and the one or more first target values; and transmit, to the one or more RAN node, the one or more second target values, wherein each of the one or more RAN nodes is configured to: receive, from the network node, the one or more second target values; determine one or more operations to be performed for managing energy consumption for the RAN node based on at least the one or more second target values.

In some embodiments, the network node is a network node of the second or third aspect. In some embodiments, the one or more RAN nodes are RAN nodes of the fifth or sixth aspect.

With some embodiments of the present disclosure, a closed loop controller and an ML/AI based solution may be combined together to avoid KPI degradation while energy saving can still be achieved.

### BRIEF DESCRIPTION OF THE DRAWINGS

FIG. 1 is a diagram illustrating an exemplary system for energy saving according to an embodiment of the present disclosure.

FIG. 2 is a diagram illustrating an exemplary system for KPI assurance for energy saving according to an embodiment of the present disclosure.

FIG. 3 is a flow chart illustrating an exemplary method for KPI assurance for energy saving according to an embodiment of the present disclosure.

FIG. 4 is a flow chart illustrating an exemplary method at a network node for facilitating a RAN in managing its energy consumption according to an embodiment of the present disclosure.

FIG. 5 is a flow chart illustrating an exemplary method at a RAN node for managing its energy consumption according to an embodiment of the present disclosure.

FIG. 6 schematically shows an embodiment of an arrangement which may be used in a network node or a RAN node according to an embodiment of the present disclosure.

FIG. 7 is a block diagram of an exemplary network node according to an embodiment of the present disclosure.

FIG. 8 is a block diagram of an exemplary RAN node according to an embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, although the following description of some embodiments of the present disclosure is given in the context of 4G LTE (Long Term Evolution), the present disclosure is not limited thereto. In fact, as long as KPI assurance for energy saving is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), LTE-Advance (LTE-A), or 5G New Radio (NR), etc. Therefore, one skilled in the arts could readily understand that the terms used herein may also refer to their equivalents in any other infrastructure. For example, the term “User Equipment” or “UE” used herein may refer to a terminal device, a mobile device, a mobile terminal, a mobile station, a user device, a user terminal, a wireless device, a wireless terminal, or any other equivalents. For another example, the term “network node” used herein may refer to a network function, a network element, a RAN node, an OAM node, a testing network function, a transmission reception point (TRP), a base station, a base transceiver station, an access point, a hot spot, a NodeB, an Evolved NodeB (eNB), a gNB, or any other equivalents. Further, the term “electronic device” used herein may refer to any of above listed devices.

Further, the following 3^{rd} Generation Partnership Project (3GPP) document is incorporated herein by reference in its entirety:
3GPP TR 37.817 V17.0.0 (2022-04), Technical Report (TR), 3rd Generation Partnership Project; Technical Specification Group Radio Access Network; Evolved Universal Terrestrial Radio Access (E-UTRA) and NR; Study on enhancement for Data Collection for NR and EN-DC (Release 17).

As mentioned above, RAN network energy consumption is one of RAN industry's biggest challenges from both cost and environmental perspectives. How to reduce energy consumption and carbon emissions while meeting the demands of expected massive data traffic growth is becoming a hot topic. For telecoms vendors, energy saving/efficiency will be a key competitive differentiator, at all levels of the stack. For example, The Global System for Mobile communication Association (GSMA) Intelligence Network Transformation Survey indicates that more than 90% of operators rate energy efficiency and sustainability as a priority.

Efficient energy consumption can also be achieved by means such as reduction of load, coverage modification, or other RAN configuration adjustments. The optimal energy saving decision depends on factors including the load situation at different RAN nodes, RAN nodes capabilities, KPI/Quality of Service (QoS) requirements, number of active User Equipments (UEs) and UE mobility, cell utilization, etc.

However, the identification of actions aimed at energy efficiency improvements is not a trivial task. Wrong switch-off of the cells/Radio Unit (RU) component for energy saving may seriously deteriorate the network performance since the remaining active cells/RU components still need to serve the traffic. Wrong energy saving actions may lead to a deterioration of network KPI which is forbidden by operators.

To deal with issues listed above, Machine Learning (ML)/Artificial Intelligence (AI) could be utilized to optimize the energy saving decisions by leveraging on the data collected in the RAN network. In 3GPP Technical Report (TR) 37.817, V17.0.0, some recommendations (chapter 5.1.2) of ML implementation are listed.

In details, ML/AI algorithms could contribute:
1. Prediction: ML/AI predicts the energy consumption and/or load state of the next period, which can be used to make better decisions on energy saving.
2. Decision Making: Based on the predicted load, ML/AI could configure the energy-saving strategy to keep a balance between system performance and energy efficiency.

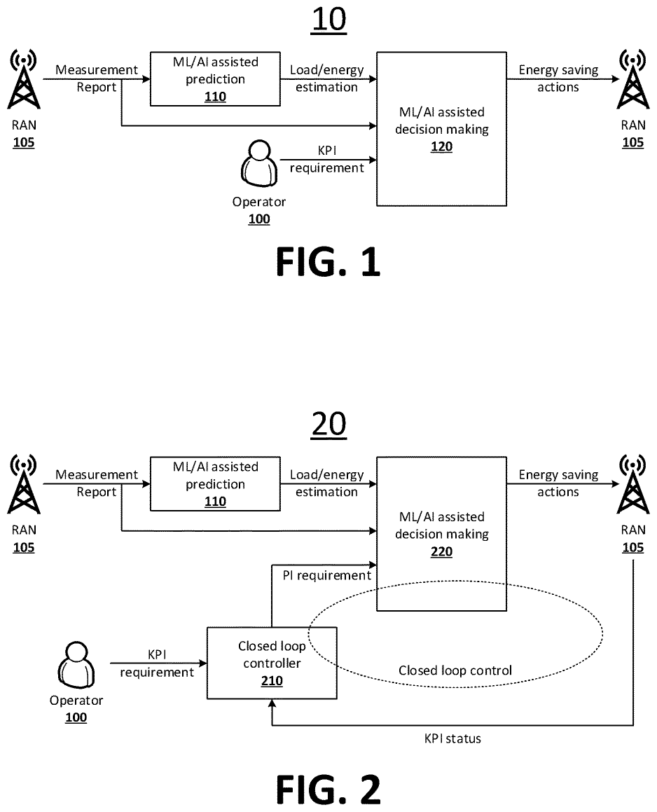

FIG. 1 is a diagram illustrating an exemplary system 10 for energy saving according to an embodiment of the present disclosure. As shown in FIG. 1, the system may comprise one or more RAN nodes 105, an ML/AI assisted prediction module 110, and an ML/AI assisted decision making module 120. As described above and as shown in FIG. 1, the ML/AI assisted prediction module 110 may predict or estimate the load state/energy consumption for the next period based on the measurement reports collected from the RAN nodes 105. As also described above and as also shown in FIG. 1, the ML/AI assisted decision making module 120 may make decisions regarding to which of the energy saving actions/operations is/are to be performed by the RAN nodes 105 based on, for example, the predicted load/energy information from the ML/AI assisted prediction module 110, the measurement reports collected from the RAN nodes 105, and/or the KPI requirements input by the operator 100 of the RAN nodes. Once the decisions are made, the ML/AI assisted decision making module 120 may trigger the RAN nodes 105 to perform corresponding actions/operations for energy saving.

There are many prediction algorithms, e.g., LSTM (Long/Short-Term Memory), DNN (Deep Neural Network), Decision Tree etc., and 2 kinds of principles behind those algorithms are briefly introduced as follows.

### Causality Based Prediction

Causality, referring to the causal relationship between variables, is attracting growing interest for its effectiveness in enhancing the interpretability and robustness of predictable models.

Causality based prediction becomes more powerful since big data technologies are voraciously accumulating massive data crossing different domains, which makes it possible to discover the causal mechanism in systems. Then the discovered causality enables prediction of systems' behaviors to automate their control.

One example of causality-based prediction is railway cell's load estimation. Based on big data, ML/AI learns that, for some cells, most of traffic comes from the passengers on a train and the train travels along a specific trajectory, e.g., moving from cell A to cell B and then cell C. Therefore, if cell A has a high traffic load, then cell C could have a high traffic load prediction in next few minutes based on causality-based prediction.

### Correlation Based Prediction

It exploits correlation of traffic and other factors, for example temporal correlation, that is, the statistical relationship between the current traffic and the historical traffic in same cell (temporal correlation). Such an approach is effective in predicting the regular components in traffic. For example, a cell covers office always has high traffic Monday to Friday but low traffic at weekend.

Further, there is an energy performance optimizer (EPO) which uses the ML/AI techniques to make decisions while guarantees KPI requirements. Based on predicted the future load, measurement, and time/date information, the EPO may use reinforcement learning to directly determine actions for energy saving. EPO may automatically generate energy saving parameter to gNBs. It tries to meet operator's KPI requirement and set KPI requirement as rewards in reinforcement learning.

Even though ML/AI based solution contribute a lot to accuracy of traffic prediction and decision making, which outperforms legacy solutions without ML/AI. However, it secures good performance only with a certain possibility due to some restrictions.

Restrictions of different ML/AI based solutions may comprise but not limited to:

### Restriction of Causality Based Prediction

A school building, stadium, or airport generates more data traffic when there are lectures, sport games, or frequent flights, respectively. In other words, lectures, sport games, and frequent flights are the main causes for traffic spikes in the above areas.

Furthermore, the time from the start to the end of an event, the popularity, the date (holiday or weekdays), the weather, and traffic jam may also influence the traffic variations. These factors are coupled with each other via complex relationships. Unfortunately, it is difficult (too expensive or law-forbidden) for operators to get such social information, hence RAN could only get partial or even none of effective social information. This will restrict the accuracy of causality-based traffic prediction.

### Restrictions of Correlation Based Prediction

In an office building, data traffic is high in working days. Temporal correlation at a week level can predict a trend of traffic load in most cases (Monday morning traffic load is highly correlated with another Monday morning).

While some yearly events, for example, public holidays, are hard to be captured for ML/AI considering data collection cost. For another example, the Chinese New Year occurs according to a lunar calendar, and therefore it is hard for ML/AI to learn/predict with simple temporal correlation of weekly data or even yearly data.

### Restrictions of ML/AI Based Decision Making

There are 2 key inputs to ML/AI based decision making:
1. Prediction of future load/energy performance, e.g., as indicated by the arrow from the ML/AI assisted prediction module 110 to the ML/AI assisted decision making module 120 shown in FIG. 1.
2. Time/Date, e.g., which can be obtained or otherwise determined locally at the ML/AI assisted decision making module 120 shown in FIG. 1.

For example, if it is midnight and the predictor (e.g., the ML/AI assisted prediction module 110) informs the ML/AI based decision maker (e.g., the ML/AI assisted decision making module 120) of a high load consumption in future. The decision maker will still recommend aggressive parameters since it is midnight and near-future traffic burst will disappear soon without KPI impact according to historical data.

Performance restrictions are obvious:
1. Its performance depends on ML/AI based prediction, which has restrictions (e.g., those listed above).
2. Decision making itself uses time/date as an input, and this is similar to the restrictions for correlation based prediction, it is not robust to some social events, e.g., concerts, public holidays etc.

Since correlation- or causality-based prediction and decision making all have restrictions, ML/AI could only ‘high-possibly’ assure accuracy of prediction on traffic load, KPI impact etc.

Unfortunately, many KPIs cannot tolerate too much ‘possibility’ due to high operator ambition on KPIs. For example, some operators may have a requirement on call drop ratio: less than 1.5%, and many cells have reached 1%-1.2% even without energy saving. There is limited KPI degrade room for energy saving.

For example, if ML/AI fails to predict a heavy traffic load for a coming concert in 4 hours, the energy saving solution may cause an unacceptable call drop ratio. Therefore, ML/AI could contribute accuracy of KPI assurance only from statistic point of view, while some KPIs need consider almost the worst case. Purely rely on ML/AI is not enough for KPI assurance of energy saving.

To handle ML/AI's “high performance but low certainty” issue, some embodiments of the present disclosure propose 2 key inventive steps:
Combine “low performance but high certainty” traditional closed loop controller and “high performance but low certainty” ML/AI based controller together to guarantee KPI requirements.
To avoid oscillation commander from ML/AI and traditional closed loop controller (i.e., two commanders for one target), some embodiments of the present disclosure use a closed loop controller to guarantee KPI requirement fulfillment, and ML/AI to guarantee PI requirement fulfillment. The closed loop controller may be responsible to translate KPI Requirements to PI Requirements.

In some embodiments, a traditional closed loop controller and ML/AI based solution may be combined together. In some embodiments, a closed loop controller may focus on KPI requirement fulfillment, and ML/AI may focus on PI requirement fulfillment. In some embodiments, a closed loop controller may be responsible to translate KPI Requirements to PI Requirements.

FIG. 2 is a diagram illustrating an exemplary system 20 for KPI assurance for energy saving according to an embodiment of the present disclosure. As shown in FIG. 2, the system 20 may comprise one or more RAN nodes 105, an ML/AI assisted prediction module 110, an ML/AI assisted decision making module 220, and a closed loop controller 210. In some embodiments, the ML/AI assisted decision making module 220 may be a part of a RAN node 105 and/or executed by the RAN node 105. In some embodiments, the closed loop controller 210 may be a part of an O&M node and/or executed by the O&M node.

As shown in FIG. 2, the ML/AI assisted prediction module 110 may predict or estimate the load state/energy consumption for the next period based on the measurement reports collected from the RAN nodes 105, for example, in a similar manner as that shown in FIG. 1.

As shown in FIG. 2, the closed loop controller 210 may translate one or more KPI requirements received from the operator 100 into one or more PI requirements based on at least the current KPI status collected from the RAN nodes 105. As also shown in FIG. 2, the ML/AI assisted decision making module 220 may make decisions regarding to which of the energy saving actions/operations is/are to be performed by the RAN nodes 105 based on, for example, the predicted load/energy information from the ML/AI assisted prediction module 110, the measurement reports collected from the RAN nodes 105, and/or the PI requirements determined by the closed loop controller 210. Once the decisions are made, the ML/AI assisted decision making module 220 may trigger the RAN nodes 105 to perform corresponding actions/operations for energy saving.

Therefore, with some embodiments of the present disclosure, ML/AI applications (e.g., the ML/AI assisted decision making module 220) are enabled for some strict KPI assurance for energy saving.

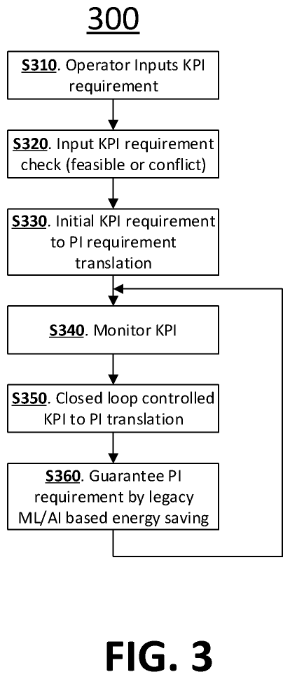

FIG. 3 is a flow chart illustrating an exemplary method 300 for KPI assurance for energy saving according to an embodiment of the present disclosure. In some embodiments, the method 300 may be performed by the system 20 shown in FIG. 2. The method 300 may comprise steps S310 through S360. However, the present disclosure is not limited thereto. In some other embodiments, the method 300 may comprise more steps, less steps, different steps, or any combination thereof. Further the steps of the method 300 may be performed in a different order than that described herein when multiple steps are involved. Further, in some embodiments, a step in the method 300 may be split into multiple sub-steps and performed by different entities, and/or multiple steps in the method 300 may be combined into a single step. Next, the method 300 will be described in detail with reference to FIG. 2.

As shown in FIG. 3, the method 300 may begin with the step S310 where the operator 100 may input its required KPI requirement(s).

At step S320, the system 20 (or the closed loop controller 210) may check the KPI requirement feasibility, for example, whether it is feasible and/or whether any requirements conflict to each other. If the check fails, the system 20 (or the closed loop controller 210) may raise an alarm to the operator 100.

At step S330, the closed loop controller 210 may initially translate the KPI requirement(s) into PI requirement(s).

A loop is executed from step S340 through step S360:
at step S340, the current KPI status may be monitored. In some embodiments, the current KPI status may be continuously monitored. In some embodiments, continuous monitoring of the current KPI status may comprise (but not limited to): periodically monitoring, event-based (aperiodic) monitoring, or both. In some embodiments, the monitoring may comprise at least one of: polling the RAN 105 by the closed loop controller 210 and receiving reports from the RAN 105.
at step S350, the closed loop controller 210 may generate new PI requirement(s) based on current KPI measurements from RAN nodes 105 and KPI requirement from the operator 100:
   inputs: current KPI status and KPI requirement;
   outputs: PI requirement;
   control target: KPI meet KPI requirement.
at step S360, ML/AI based energy saving solution (e.g., the ML/AI assisted decision making module 220) may try to guarantee the new PI requirement from the closed loop controller 210.

While the loop is continuously executed, a closed loop control is formed.

In some embodiments, the term “KPI” may represent the end-user perception of a network on a macro level. Operators may use KPI statistics to compare networks against each other, and/or to detect problems and errors.

For example, KPI may include at least one of (but not limited to):
Accessibility, including connection setup success ratio, random access ratio etc.
Retainability, including session time normalized loss ratio etc.
Integrity, including average UE latency, UE throughput, package loss ratio etc.
Mobility, including handover success rate etc.
Availability, including cell availability etc.

In some embodiments, an operator may have specific requirement(s) on KPI, for example, mobility KPI handover success rate >98%. This requirement may be set based on the operator's own business consideration.

In some embodiments, energy saving feature tends to impact KPI and tolerance threshold (KPI requirement) should be set by operator manually. However, manual operation means potential unreasonable input. RAN should check the operator input KPI requirement about:
Feasibility: for example, a cell without any energy saving “on” can only reach a call drop rate of 2%, while an operator wants energy saving functions to guarantee a call drop rate of <1%. This is not feasible, and the network should notify the operator that the KPI requirement may be not feasible. In some embodiments, to implement the feasibility-check of KPI requirement, energy saving functions should log KPI performance when energy saving function “off” in history.
No conflict: KPI A's requirement should not be conflict with KPI B's requirement. For example, high QOS UE's integrity (e.g., latency) requirement is worse than low QoS UE's integrity.

In some embodiments, the term “PI” may represent system level information that explains the KPI results. In some embodiments, a PI may be information that is non-perceptible by an end user. In some embodiments, a PI may be information that is only perceptible by a RAN and/or its operator. Many PIs can be used for Root Cause Analysis. PIs can also be in the form of metrics that show specific parts of the system can perform. PIs usually have an impact on KPIs.

PI for energy saving ML/AI decision making may include at least one of (but not limited to):
Max Path loss Indicating max pathloss that support KPI (including accessibility, retainability and mobility) requirement.
MAC layer scheduling latency: Indicating max MAC layer scheduling latency that support integrity (latency) requirement.
a schedulable physical layer channel capacity.
a schedulable session per TTI.
Referring back to FIG. 2, there are many solutions for the implementations of the closed loop controller 210. Here one of them, the Deviation Controller based solution, will be described:

$$PI Requirement ( new ) = D * ( KPI ( new ) - KPI requirement ) + PI Requirement ( old )$$

where D is a constant indicating how sensitive the PI is to the difference between KPI and KPI requirement.

Next, a specific example of the Deviation Controller based procedure at the closed loop controller 210 will be described in detail. Assuming the initial max path loss threshold=−120 dB (i.e., a PI requirement), D is 100, and a KPI requirement is call drop rate <=2%.
1 (e.g., step S340). With ML/AI decision making 220, the current KPI status is: call drop rate=3%.
2 (e.g., step S350). The closed loop controller 210 will adjust the PI requirement according to the updated (or the latest) KPI status, the new max path loss threshold=100*(3%−2%)+(−120)=−119 dB.
3 (e.g., step S360). ML/AI 220 will make a decision based on: the max path loss threshold=−119 dB. ML/AI decision making 220 will be more conservative on energy saving.
4 (e.g., step S340 in a new cycle). KPI is improved a bit, say current KPI status is: call drop rate=2.1%.
5 (e.g., step S350 in the new cycle). RAN 105 updates new KPI status, then the closed loop controller 210 will update max path loss threshold=100*(2.1%−2%)+(−119)=−118.9 dB;
6 (e.g., step S360 in the new cycle). ML/AI 220 will make decision based on: max path loss threshold=−118.9 dB.
7 . . . loop like 1-6.

In general, the closed loop controller 210 may work like a safe belt to the ML/AI 220, to guarantee KPI could be controlled well aligned with requirement even ML/AI make mistakes occasionally.

Although some embodiments with only a single PI and a single KPI are described above, the present disclosure is not limited thereto. In some embodiments, a single PI may be determined based on multiple KPIs. In some embodiments, multiple PIs may be determined based on a single KPI. In some embodiments, multiple PIs may be determined based on multiple KPIs. In other words, an one-to-one, one-to-many, many-to-one, or many-to-many mapping between the KPIs and the PIs may be possible in different embodiments, or even in different cycles.

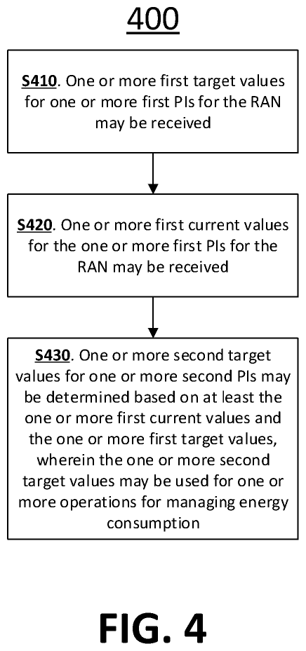

FIG. 4 is a flow chart of an exemplary method 400 at a network node for facilitating a RAN in managing its energy consumption according to an embodiment of the present disclosure. The method 400 may be performed at a network node (e.g., the closed loop controller 210). The method 400 may comprise steps S410, S420, and S430. However, the present disclosure is not limited thereto. In some other embodiments, the method 400 may comprise more steps, less steps, different steps, or any combination thereof. Further the steps of the method 400 may be performed in a different order than that described herein when multiple steps are involved. Further, in some embodiments, a step in the method 400 may be split into multiple sub-steps and performed by different entities, and/or multiple steps in the method 400 may be combined into a single step.

The method 400 may begin at step S410 where one or more first target values for one or more first PIs for the RAN may be received.

At step S420, one or more first current values for the one or more first PIs for the RAN may be received.

At step S430, one or more second target values for one or more second PIs may be determined based on at least the one or more first current values and the one or more first target values, wherein the one or more second target values may be used for one or more operations for managing energy consumption.

In some embodiments, the one or more first PIs may indicate one or more performance metrics for the RAN that are perceptible by an end user. In some embodiments, the one or more first PIs may indicate at least one of: a performance metric in term of accessibility; a performance metric in term of retainability; a performance metric in term of integrity; a performance metric in term of mobility; and a performance metric in term of availability. In some embodiments, the one or more second PIs may indicate one or more performance metrics for status of the RAN that are non-perceptible by an end user. In some embodiments, the one or more second PIs may indicate at least one of: a maximum path loss; a MAC layer scheduling latency; a schedulable physical layer channel capacity; and a schedulable session per TTI.

In some embodiments, the step of receiving the one or more first target values may comprise: receiving, from an operator of the RAN, the one or more first target values. In some embodiments, the method 400 may further comprise at least one of: determining whether the one or more first target values are feasible or not; and determining whether the first target values conflict to each other or not when there are multiple first target values. In some embodiments, the method 400 may further comprise: providing the operator of the RAN with an alarm in response to determining at least one of: at least one of the first target values is not feasible; and at least two of the first target values conflict to each other. In some embodiments, the method 400 may further comprise: determining baseline values for the one or more first PIs, each of which indicating a performance metric without performing any operation for energy saving, wherein the step of determining whether the one or more first target values are feasible or not may comprise at least one of: determining at least one of the first target values is not feasible in response to determining that the at least one first target value indicates a requirement higher than that indicated by at least one corresponding baseline value; and determining all the first target values are feasible in response to determining that each of the first target values indicates a requirement lower than or equal to that indicated by a corresponding baseline value.

In some embodiments, the step of determining whether the first target values conflict to each other or not when there are multiple first target values may comprise at least one of: determining that the multiple first target values do not conflict to each other in response to determining that none of the multiple first target values indicates a requirement conflicting to that indicated by any other of the multiple first target values; and determining that at least two of the multiple first target values conflict to each other in response to determining that the at least two first target values indicate requirements conflicting to each other. In some embodiments, the step of receiving the one or more first current values may comprise: monitoring the RAN for its current values for the one or more first PIs.

In some embodiments, the step of determining the one or more second target values may comprise: performing a closed loop control procedure to determine the one or more second target values based on at least the one or more first current values and the one or more first target values, wherein the one or more first current values and the one or more first target values may be inputs to the closed loop control procedure, the one or more second target values may be outputs from the closed loop control procedure, and a control target for the closed loop control procedure may be at least one of: have the one or more first current values meet the one or more first target values; minimize differences between the one or more first current values and the one or more first target values, respectively; minimize a difference between at least one of the first current values and its corresponding first target value; and have the one or more first current values meet the one or more first target values to the maximum extent. In some embodiments, the closed loop control procedure may be a deviation based control procedure. In some embodiments, a second target value for a second PI may be determined as a sum of a second target value for the second PI in a previous cycle and an adjustment value, wherein the adjustment value may be determined as a product of a constant and a difference between a first current value for a first PI and a first target value for the first PI.

In some embodiments, a mapping between the one or more first PIs and the one or more second PIs may be predetermined or configured, wherein the mapping may indicate which one or ones of the first PIs are involved in determining a second target value for a second PI. In some embodiments, the method 400 may further comprise: triggering the RAN to perform the one or more operations for managing energy consumption based on at least the one or more second target values. In some embodiments, the step of triggering the RAN to perform one or more operations may comprise: transmitting, to one or more RAN nodes in the RAN, the one or more second target values to enable the one or more RAN nodes to determine the one or more operations to be performed based on at least the one or more second target values and one or more second current values for the one or more second PIs.

In some embodiments, the one or more first current values and the one or more second target values may be periodically determined. In some embodiments, the network node may comprise an Operations & Maintenance (O&M) node.

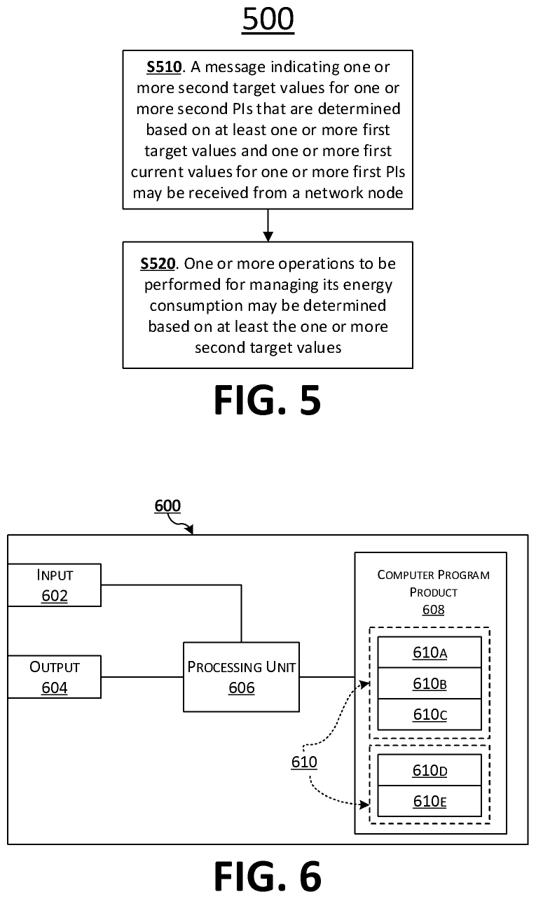

FIG. 5 is a flow chart of an exemplary method 500 at a RAN node for managing its energy consumption according to an embodiment of the present disclosure. The method 500 may be performed at a RAN node (e.g., the ML/AI assisted decision making module 220). The method 500 may comprise steps S510 and S520. However, the present disclosure is not limited thereto. In some other embodiments, the method 500 may comprise more steps, less steps, different steps, or any combination thereof. Further the steps of the method 500 may be performed in a different order than that described herein when multiple steps are involved. Further, in some embodiments, a step in the method 500 may be split into multiple sub-steps and performed by different entities, and/or multiple steps in the method 500 may be combined into a single step.

The method 500 may begin at step S510 where one or more second target values for one or more second PIs that are determined based on at least one or more first target values and one or more first current values for one or more first PIs may be received from a network node.

At step S520, one or more operations to be performed for managing its energy consumption may be determined based on at least the one or more second target values.

In some embodiments, the one or more first PIs may indicate one or more performance metrics that are perceptible by an end user. In some embodiments, the one or more first PIs may indicate at least one of: a performance metric in term of accessibility; a performance metric in term of retainability; a performance metric in term of integrity; a performance metric in term of mobility; and a performance metric in term of availability. In some embodiments, the one or more second PIs may indicate one or more performance metrics that are non-perceptible by an end user. In some embodiments, the one or more second PIs may indicate at least one of: a maximum path loss; a MAC layer scheduling latency; a schedulable physical layer channel capacity; and a schedulable session per TTI. In some embodiments, the step of determining one or more operations may comprise: determining the one or more operations by an ML/AI assisted decision making module based on at least one of: the one or more second target values; a measurement report; a load estimation; and an energy estimation. In some embodiments, the one or more second target values may be periodically received and the one or more operations to be performed for managing its energy consumption may be periodically determined. In some embodiments, the method 500 may further comprise: performing the one or more operations.

FIG. 6 schematically shows an embodiment of an arrangement 600 which may be used in a network node (e.g., the closed loop controller 210) or a RAN node (e.g., the ML/AI assisted decision making module 220) according to an embodiment of the present disclosure. Comprised in the arrangement 600 are a processing unit 606, e.g., with a Digital Signal Processor (DSP) or a Central Processing Unit (CPU). The processing unit 606 may be a single unit or a plurality of units to perform different actions of procedures described herein. The arrangement 600 may also comprise an input unit 602 for receiving signals from other entities, and an output unit 604 for providing signal(s) to other entities. The input unit 602 and the output unit 604 may be arranged as an integrated entity or as separate entities.

Furthermore, the arrangement 600 may comprise at least one computer program product 608 in the form of a non-volatile or volatile memory, e.g., an Electrically Erasable Programmable Read-Only Memory (EEPROM), a flash memory and/or a hard drive. The computer program product 608 comprises a computer program 610, which comprises code/computer readable instructions, which when executed by the processing unit 606 in the arrangement 600 causes the arrangement 600 and/or the network node and/or the RAN node in which it is comprised to perform the actions, e.g., of the procedure described earlier in conjunction with FIG. 2 through FIG. 5 or any other variant.

The computer program 610 may be configured as a computer program code structured in computer program modules 610A, 610B, and 610C. Hence, in an exemplifying embodiment when the arrangement 600 is used in a network node for facilitating a RAN in managing its energy consumption, the code in the computer program of the arrangement 600 includes: a module 610A configured to receive one or more first target values for one or more first PIs for the RAN; a module 610B configured to receive one or more first current values for the one or more first PIs for the RAN; and a module 610C configured to determine one or more second target values for one or more second PIs based on at least the one or more first current values and the one or more first target values, wherein the one or more second target values are used for one or more operations for managing energy consumption.

Alternatively or additionally, the computer program 610 may be further configured as a computer program code structured in computer program modules 610D and 610E. Hence, in an exemplifying embodiment when the arrangement 600 is used in a RAN node for managing its energy consumption, the code in the computer program of the arrangement 600 includes: a module 610D configured to receive, from a network node, one or more second target values for one or more second PIs that are determined based on at least one or more first target values and one or more first current values for one or more first PIs; and a module 610E configured to determine one or more operations to be performed for managing its energy consumption based on at least the one or more second target values.

The computer program modules could essentially perform the actions of the flow illustrated in FIG. 3 through FIG. 5, to emulate the network node and/or the RAN node. In other words, when the different computer program modules are executed in the processing unit 606, they may correspond to different modules in the network node and/or the RAN node.

Although the code means in the embodiments disclosed above in conjunction with FIG. 6 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within the network node and/or the RAN node.

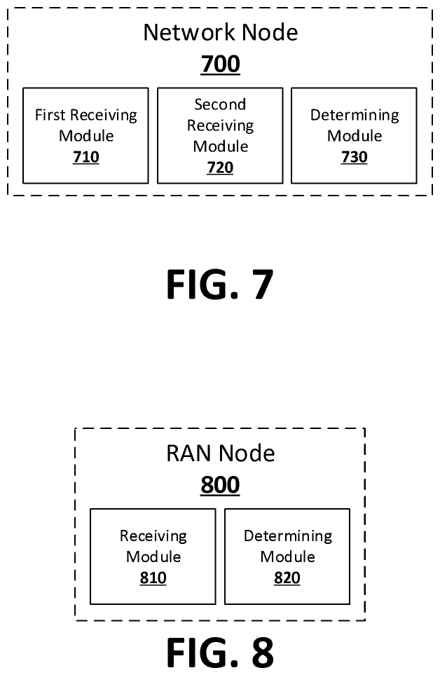

Correspondingly to the method 400 as described above, a network node for facilitating a RAN in managing its energy consumption is provided. FIG. 7 is a block diagram of an exemplary network node 700 according to an embodiment of the present disclosure. The network node 700 may be, e.g., the closed loop controller 210 in some embodiments.

The network node 700 may be configured to perform the method 400 as described above in connection with FIG. 4. As shown in FIG. 7, the network node 700 may comprise a first receiving module 710 configured to receive one or more first target values for one or more first PIs for the RAN; a second receiving module 720 configured to receive one or more first current values for the one or more first PIs for the RAN; and a determining module 730 configured to determine one or more second target values for one or more second PIs based on at least the one or more first current values and the one or more first target values, wherein the one or more second target values are used for one or more operations for managing energy consumption.

The above modules 710, 720, and/or 730 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4. Further, the network node 700 may comprise one or more further modules, each of which may perform any of the steps of the method 400 described with reference to FIG. 4.

Correspondingly to the method 500 as described above, a RAN node for managing its energy consumption is provided. FIG. 8 is a block diagram of an exemplary RAN node 800 according to an embodiment of the present disclosure. The RAN node 800 may be, e.g., the ML/AI assisted decision making module 220 in some embodiments.

The RAN node 800 may be configured to perform the method 500 as described above in connection with FIG. 5. As shown in FIG. 8, the RAN node 800 may comprise a receiving module 810 configured to receive, from a network node, one or more second target values for one or more second PIs that are determined based on at least one or more first target values and one or more first current values for one or more first PIs; and a determining module 820 configured to determine one or more operations to be performed for managing its energy consumption based on at least the one or more second target values.

The above modules 810 and/or 820 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 5. Further, the RAN node 800 may comprise one or more further modules, each of which may perform any of the steps of the method 500 described with reference to FIG. 5.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1-34. (canceled)

35. A method at a network node for facilitating a Radio Access Network (RAN) in managing its energy consumption, the method comprising:
receiving one or more first target values for one or more first performance indicators (PIs) for the RAN;
receiving one or more first current values for the one or more first PIs for the RAN; and
determining one or more second target values for one or more second PIs based on at least the one or more first current values and the one or more first target values,
wherein the one or more second target values are used for one or more operations for managing energy consumption.

36. The method of claim 35, wherein the one or more first PIs indicate one or more performance metrics for the RAN that are perceptible by an end user.

37. The method of claim 35, wherein the one or more first PIs indicate at least one of:
a performance metric in term of accessibility;
a performance metric in term of retainability;
a performance metric in term of integrity;
a performance metric in term of mobility; and
a performance metric in term of availability.

38. The method of claim 35, wherein the one or more second PIs indicate one or more performance metrics for status of the RAN that are non-perceptible by an end user.

39. The method of claim 35, wherein the one or more second PIs indicate at least one of:
a maximum path loss;
a Medium Access Control (MAC) layer scheduling latency;
a schedulable physical layer channel capacity; and
a schedulable session per Transmission Time Interval (TTI).

40. The method of claim 35, wherein the step of receiving the one or more first target values comprises:
receiving, from an operator of the RAN, the one or more first target values.

41. The method of claim 35, further comprising at least one of:
determining whether the one or more first target values are feasible or not; and
determining whether the first target values conflict to each other or not when there are multiple first target values.

42. The method of claim 41, further comprising:
providing the operator of the RAN with an alarm in response to determining at least one of:
at least one of the first target values is not feasible; and
at least two of the first target values conflict to each other.

43. The method of claim 35, further comprising:
determining baseline values for the one or more first PIs, each of which indicating a performance metric without performing any operation for energy saving,
wherein the step of determining whether the one or more first target values are feasible or not comprises at least one of:
determining at least one of the first target values is not feasible in response to determining that the at least one first target value indicates a requirement higher than that indicated by at least one corresponding baseline value; and
determining all the first target values are feasible in response to determining that each of the first target values indicates a requirement lower than or equal to that indicated by a corresponding baseline value.

44. The method of claim 35, wherein the step of determining whether the first target values conflict to each other or not when there are multiple first target values comprises at least one of:
determining that the multiple first target values do not conflict to each other in response to determining that none of the multiple first target values indicates a requirement conflicting to that indicated by any other of the multiple first target values; and
determining that at least two of the multiple first target values conflict to each other in response to determining that the at least two first target values indicate requirements conflicting to each other.

45. The method of claim 35, wherein the step of receiving the one or more first current values comprises:
monitoring the RAN for its current values for the one or more first PIs.

46. A method at a Radio Access Network (RAN) node for managing its energy consumption, the method comprising:
receiving, from a network node, one or more second target values for one or more second performance indicators (PIs) that are determined based on at least one or more first target values and one or more first current values for one or more first PIs; and
determining one or more operations to be performed for managing its energy consumption based on at least the one or more second target values.

47. The method of claim 46, wherein the one or more first PIs indicate one or more performance metrics that are perceptible by an end user.

48. The method of claim 46, wherein the one or more first PIs indicate at least one of:
a performance metric in term of accessibility;
a performance metric in term of retainability;
a performance metric in term of integrity;
a performance metric in term of mobility; and
a performance metric in term of availability.

49. The method of claim 46, wherein the one or more second PIs indicate one or more performance metrics that are non-perceptible by an end user.

50. The method of claim 46, wherein the one or more second PIs indicate at least one of:
a maximum path loss;
a Medium Access Control (MAC) layer scheduling latency;
a schedulable physical layer channel capacity; and
a schedulable session per Transmission Time Interval (TTI).

51. The method of claim 46, wherein the step of determining one or more operations comprises:
determining the one or more operations by a Machine Learning (ML)/Artificial Intelligence (AI) assisted decision making module based on at least one of:
the one or more second target values;
a measurement report;
a load estimation; and
an energy estimation.

52. The method of claim 46, wherein the one or more second target values are periodically received and the one or more operations to be performed for managing its energy consumption are periodically determined.

53. The method of claim 46, further comprising:
performing the one or more operations.

54. A Radio Access Network (RAN) node, comprising:
a processor;
a memory storing instructions which, when executed by the processor, cause the processor to perform the method of claim 46.
